(19) United States
(12) Patent Application Publication
(10) Pub. No.: US 2008/0240090 A1
(43) Pub. Date: Oct. 2, 2008

(54) PROGRAMMABLE HIGH SPEED CROSSBAR SWITCH

(75) Inventors: Deborah H. Heller, Raleigh, NC (US); Jeffrey R. McClellan, Raleigh, NC (US); James Xavier Torok, Raleigh, NC (US); Derek Braid, Raleigh, NC (US); Dale Krisher, Wake Forest, NC (US)

Correspondence Address: FOGG & POWERS LLC, 10 SOUTH FIFTH STREET, SUITE 1000, MINNEAPOLIS, MN, 55402, US

(73) Assignee: ADC DSL SYSTEMS, INC., Eden Prairie, MN (US)

(21) Appl. No.: 11/692,449

(22) Filed: Mar. 28, 2007

(51) Int. Cl. H04L 12/50

(52) U.S. Cl. 370/360

(57) ABSTRACT

A method for switching digital signals is disclosed. From an external control connection, the method configures a plurality of digital signal paths with at least one crossbar switch and controls a plurality of input and output connections for the digital signals based on the crossbar switch configuration. The method further involves automatically revising the digital signal routing without manual intervention based on configuration commands from the external control connection.

### RELATED APPLICATIONS

This application is related to commonly assigned U.S. patent application Ser. No. ______, (Attorney Docket No. 100.812US01), filed on even date herewith and entitled “CROSSBAR CABLE” (the '812 Application). The '812 Application is incorporated herein by reference.

This application is also related to the following commonly assigned applications filed on even date herewith, each of which is incorporated herein by reference:

U.S. patent application Ser. No. ______, (Attorney Docket No. 100.815US01), entitled “FAN MODULE” (the '815 Application).

U.S. patent application Ser. No. ______, (Attorney Docket No. 100.816US01), entitled “AN APPARATUS FOR COOLING ELECTRONICS” (the '816 Application).

U.S. patent application Ser. No. ______, (Attorney Docket No. 100.817US01), entitled “A CABLE MANAGEMENT COMPONENT” (the '817 Application).

U.S. patent application Ser. No. ______, (Attorney Docket No. 100.818US01), entitled “FILTER ASSEMBLY” (the '818 Application).

### BACKGROUND

As additional service demands are placed on telecommunications systems, replacement of time-sensitive operations is occurring with electronically-configurable operations (for example, programmable electronic equipment). A crossbar switch is one example. Typical crossbar switches have a characteristic matrix of switches between the inputs to a switch and the output of the switch. If the switch has A inputs and B outputs, then a crossbar has a matrix with A×B “cross-points”, or places where the “bars cross”.

Increasingly, these additional service demands involve operating at optimal speeds to accommodate simulcast transmissions of voice and data traffic on the system. Any potential routing changes of the simulcast transmissions typically require reconfiguration (that is, rerouting) of multiple telecommunications signals through the crossbar switch. The periodic rerouting involves manual removal and reinsertion of multiple connections for one or more desired configurations. The manual removal and reinsertion of the multiple connections typically introduces additional verification requirements. These additional verification requirements translate into increased operating costs to ensure the one or more desired configurations are achieved.

### SUMMARY

The following specification discusses a programmable high speed crossbar switch. This summary is made by way of example and not by way of limitation. It is merely provided to aid the reader in understanding some aspects of one or more embodiments described in the following specification. Particularly, in one embodiment, a method for switching digital signals is provided. From an external control connection, the method configures a plurality of digital signal paths with at least one crossbar switch and controls a plurality of input and output connections for the digital signals based on the crossbar switch configuration. The method further involves automatically revising the digital signal routing without manual intervention based on configuration commands from the external control connection.

### DRAWINGS

These and other features, aspects, and advantages are better understood with regard to the following description, appended claims, and accompanying drawings where:

FIG. 1 is a block diagram of a telecommunications system;

FIG. 2 is a block diagram of an electronic digital signal switching device;

FIG. 3 is a flow diagram illustrating a method for switching digital signals with the device of FIG. 2; and

FIG. 4 is a block diagram of an alternate embodiment of the telecommunications system of FIG. 1.

### DETAILED DESCRIPTION

The following detailed description describes at least one embodiment of a programmable high speed crossbar switch for simulcast transmissions in a telecommunications system. The programmable high speed crossbar switch implements electronically configurable simulcast transmissions by electronic switching of telecommunication signals between a service provider interface and remote access nodes. Advantageously, the programmable high speed crossbar switch eliminates the need for manual manipulation (that is, rerouting of telecommunications signals) of a transmission medium (for example, a plurality of telecommunications cables) in the telecommunications system.

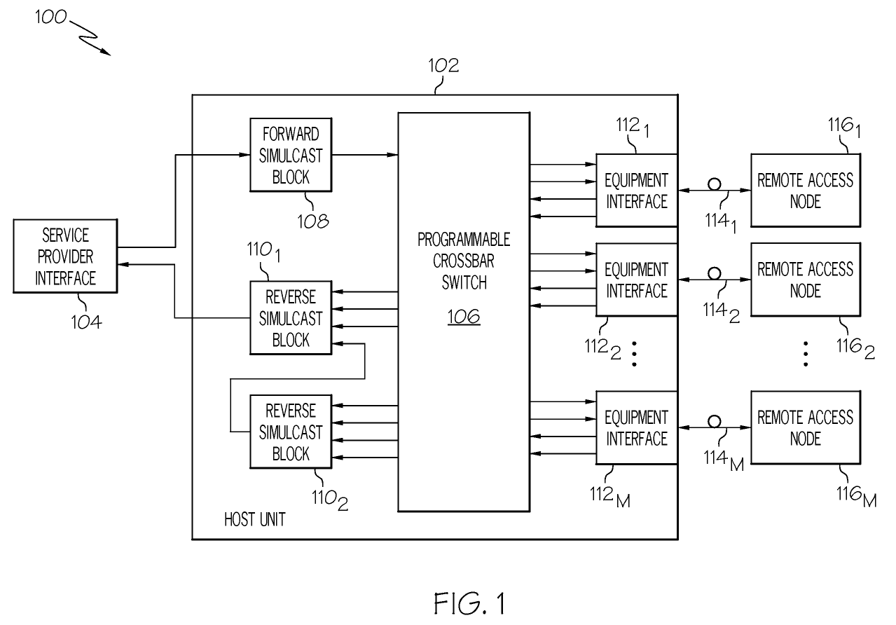

FIG. 1 is a block diagram of a telecommunications system 100. The system 100 transports communications signals for a plurality of services offered by one or more service providers and extends the coverage of these systems into a plurality of environments (for example, within an enclosed structure) through at least one programmable crossbar switch 106 in a host unit 102. The system 100 comprises a service provider interface 104, the host unit 102 responsive to the service provider interface 104, and remote access nodes 116₁ to 116_{M} coupled to the host unit 102 by respective equipment interfaces 112₁ to 112_{M}. The host unit 102 further includes a forward simulcast block 108 responsive to the service provider interface 104, and reverse simulcast blocks 110₁ and 110₂. The reverse simulcast blocks 110₁ and 110₂ are connected in series and provide additional capabilities for reverse simulcast transmissions from the remote access nodes 116₁ to 116_{M} to the service provider interface 104. In the example embodiment of FIG. 1, the remote access nodes 116₁ to 116_{M} comprise a plurality of simulcast transmitting stations that are spatially distributed throughout a broadcast area and transmit substantially at the same carrier frequency.

The programmable crossbar switch 106 provides at least one automated data signal path configuration between the forward simulcast block 108 and the reverse simulcast blocks 110₁ to 110₂ in electronic simulcast telecommunications transmissions between the service provider interface 104 and the one or more remote access nodes 116. It is understood that the system 100 is capable of accommodating any appropriate number of the reverse simulcast blocks 110 and the remote access nodes 116 (for example, one or more reverse simulcast blocks 110 and one or more remote access nodes 116) in a single system 100. The one or more remote access nodes 116 are coupled to the programmable crossbar switch 106 through the equipment interfaces 112₁ to 112_{M}. In the example embodiment of FIG. 1, the equipment interfaces 112₁ to 112_{M} represent one or more synchronous interfaces. The equipment interfaces 112₁ to 112_{M} support the one or more remote access nodes 116 with at least one automated data signal path configuration through the programmable crossbar switch 106.

The service provider interface 104 comprises, for example, an interface to one or more of a base transceiver station (BTS), a repeater, a bi-directional amplifier, a base station hotel or other appropriate interface for one or more service provider communications networks. In one implementation, the service provider interface 104 provides an interface to a plurality of services from one or more service providers such as, but not limited to, digital cellular service, Personal Communication Services (PCS), Specialized Mobile Radio (SMR) services, video services, wireless broadband internet services, and other appropriate telecommunication services.

The system 100 uses at least two main transport protocols to extend coverage of simulcast telecommunication services throughout the plurality of environments covered by the remote access nodes 116. The system 100 uses a digital transport over the communication mediums 114₁ to 114_{M} (for example, optical fiber). The communication mediums 114₁ to 114_{M} are represented as optical fiber in FIG. 1 by way of example and not by way of limitation. In other embodiments, the communication mediums 114₁ to 114_{M} comprises one or more of free space optics, high speed copper and other appropriate wired, wireless (RF), and optical communication mediums. The system 100 uses the digital transport technology present in the communication mediums 114₁ to 114_{M} for simulcast communication transmissions between the host unit 102 and the remote access nodes 116. By connecting one or more additional programmable crossbar switches 106 in series (not shown), additional remote access nodes (similar to the remote access nodes 116) are serviceable by the host unit 102. The one or more additional programmable crossbar switches 106 allow the host unit 102 to supply one or more simulcast telecommunications services over a substantially larger coverage area.

In operation, the system 100 extends the coverage of simulcast communication transmission services from the host unit 102 to the remote access nodes 116 with the programmable crossbar switch 106. The system 100 receives forward signals (that is, voice and data communications) at the service provider interface 104. The host unit 102 receives the forward signals and routes the forward signals as determined by the programmable crossbar switch 106 to the appropriate equipment interface 112. In one implementation, the forward signals are amplified, combined, and transmitted from the equipment interfaces 112 over the communication mediums 114₁ to 114_{M} to the respective remote access nodes 116. At the remote access nodes 116, reverse signals are returned (at substantially the same time for a reverse simulcast transmission) over the communication mediums 114₁ to 114_{M} to the host unit 102. The equipment interfaces 112 route the reverse signals to the reverse simulcast blocks 110 through the programmable crossbar switch 106.

The programmable crossbar switch 106 implements electronically configurable simulcast transmissions by electronic switching of telecommunication signals between the service provider interface 104 and the remote access nodes 116. The programmable crossbar switch 106 eliminates the manual patching of the telecommunication signals (that is, the telecommunications cables) for ongoing signal path rerouting and reconfiguration. The programmable crossbar switch 106 works in conjunction with the forward simulcast block 108, the reverse simulcast blocks 110₁ and 110₂ and the equipment interfaces 112₁ to 112_{M} to complete simulcast telecommunication signal coverage in a plurality of environments.

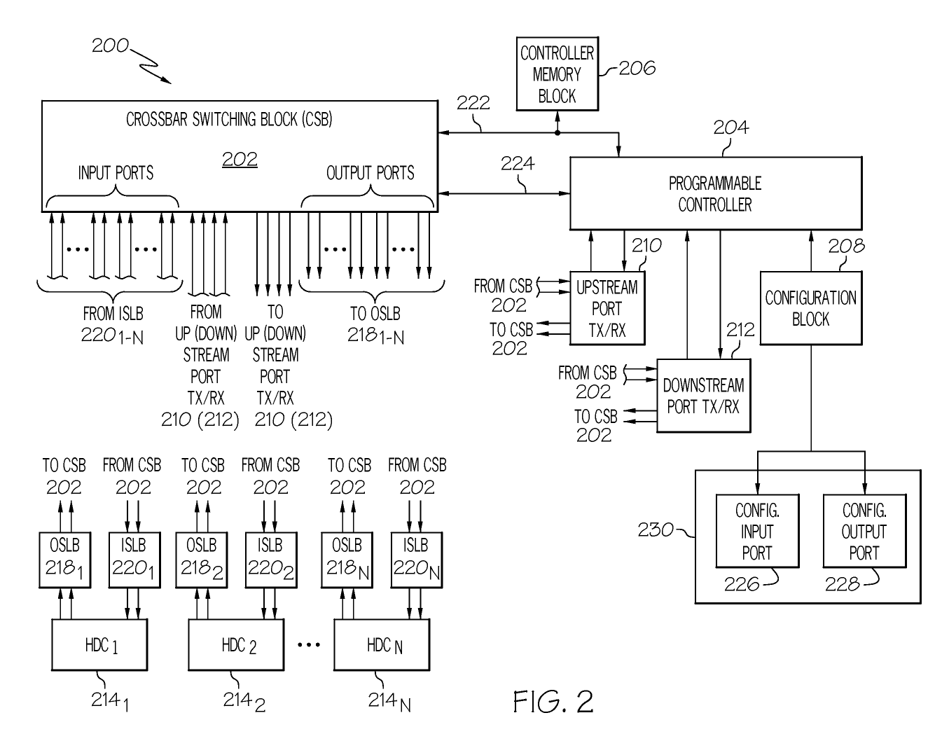

FIG. 2 is a block diagram of an electronic digital signal switching device 200, representative of the programmable high speed crossbar switch 106 in the system 100. The device 200 comprises a crossbar switching block (CSB) 202 responsive to a programmable controller 204 (via a control interface connection 224), a controller memory block 206, and a configuration block 208 in communication with the programmable controller 204. The programmable controller 204 comprises at least one of a microcontroller, an application-specific integrated circuit (ASIC), a field-programmable gate array (FPGA), a field-programmable object array (FPOA), and a programmable logic device (PLD). Moreover, the CSB 202 comprises at least one of a microcontroller, an ASIC, an FPGA, an FPOA, and a PLD. The controller memory block 206 is responsive to the programmable controller 204 and the CSB 202 via a memory interface connection 222. In one implementation, the controller memory block 206 records a plurality of digital signal path configuration commands from the configuration block 208. The controller memory block 206 comprises at least one of a FLASH memory and an electrically-erasable programmable read-only memory (EEPROM). The programmable controller 204 and the CSB 202 are responsive to the plurality of digital signal path configuration commands received by the configuration block 208, as discussed in further detail below. In one implementation, the configuration block 208 comprises an inter-IC (integrated circuit, or I2C) bus that transfers the plurality of digital signal path configuration commands to the programmable controller 204.

The configuration block 208 receives the plurality of digital signal path configuration commands from an external control connection 230. The external control connection 230 comprises a configuration input port 226 and a configuration output port 228. In one implementation, the configuration input port 226 receives the plurality of digital signal path configuration commands from a single source (for example, an external servicing unit, or the like). In at least one alternate implementation, the configuration input port 226 receives the plurality of digital signal path configuration commands from an additional downstream (upstream) device 200 (similar to the device 200 depicted in FIG. 2), and the configuration output port 228 provides additional digital signal path configuration commands from the programmable controller 204 to one or more additional devices 200 (that is, one or more additional programmable crossbar switches 106) for routing of additional digital signals (as discussed above with respect to the system 100 of FIG. 1). In this implementation, the device 200 is considered stacked (that is, serially connected through the external control connection 230) with the one or more additional devices 200. As discussed above with respect to the system 100, stacking the devices 200 provides additional digital signal routing points to substantially increase coverage (that is, increase system capacity) of the plurality of digital signal paths.

The device 200 further comprises high density connectors (HDCs) 214₁, to 214_{N} operatively coupled to the CSB 202. The HDCs 214₁ to 214_{N} are responsive to at least one digital signal path configuration from the programmable controller 204. The assembly 200 further comprises an upstream port transmit and receive (TX/RX) block 210 and a downstream port TX/RX block 212. Both the upstream port TX/RX block 210 and the downstream port TX/RX block 212 are responsive to the programmable controller 204. The upstream (downstream) port TX/RX block 210 (212) is operatively coupled to an input (output) port section of the CSB 202, as illustrated in FIG. 2. In one implementation, each of the upstream port TX/RX block 210 and the downstream port TX/RX block 212 comprise SERializer/DESerializer (SERDES) devices. The upstream port TX/RX block 210 transmits (receives) digital signals to (from) one or more additional devices 200 stacked upstream from the device 200 depicted in FIG. 2. Similarly, the downstream port TX/RX block 212 transmits (receives) digital signals to (from) one or more additional devices 200 stacked downstream from the device 200.

The CSB 202 comprises a plurality of input ports and a plurality of output ports in communication with the HDCs 214₁ to 214₂. The plurality of input ports and the plurality of output ports provide one or more digital signal paths through the device 200 for simulcast transmissions of digital signals within the system 100. The plurality of input ports and the plurality of output ports are coupled to the HDCs 214₁ to 214_{N} by input (output) signal logic blocks 220₁ (218₁) to 220_{N} (218_{N}). The input (output) signal logic blocks 220₁ (218₁) to 220_{N} (218_{N}) comprise emitter-coupled, low voltage differential signaling (LVDS) logic for high-speed serial data transmission. The HDCs 214₁ to 214_{N} remain connected as a plurality of digital signal path connections are automatically rerouted to form the at least one digital signal path configuration while the device 200 continues to operate. As illustrated in FIG. 2, the plurality of input and output ports of the CSB 202 comprise a switching matrix between the inputs and the outputs on the HDCs 214₁ to 214_{N}. By way of example and not by way of limitation, for a number of outputs S on each of the OSLBs 218₁ to 218_{N} and a number of inputs T for each of the ISLBs 220₁ to 220_{N}, the switching matrix for the programmable crossbar swith 106 comprises S×T connection points. In one implementation, the programmable controller 204 completes a configuration update of the at least one digital signal path configuration at a switching rate of at least 720 MHz.

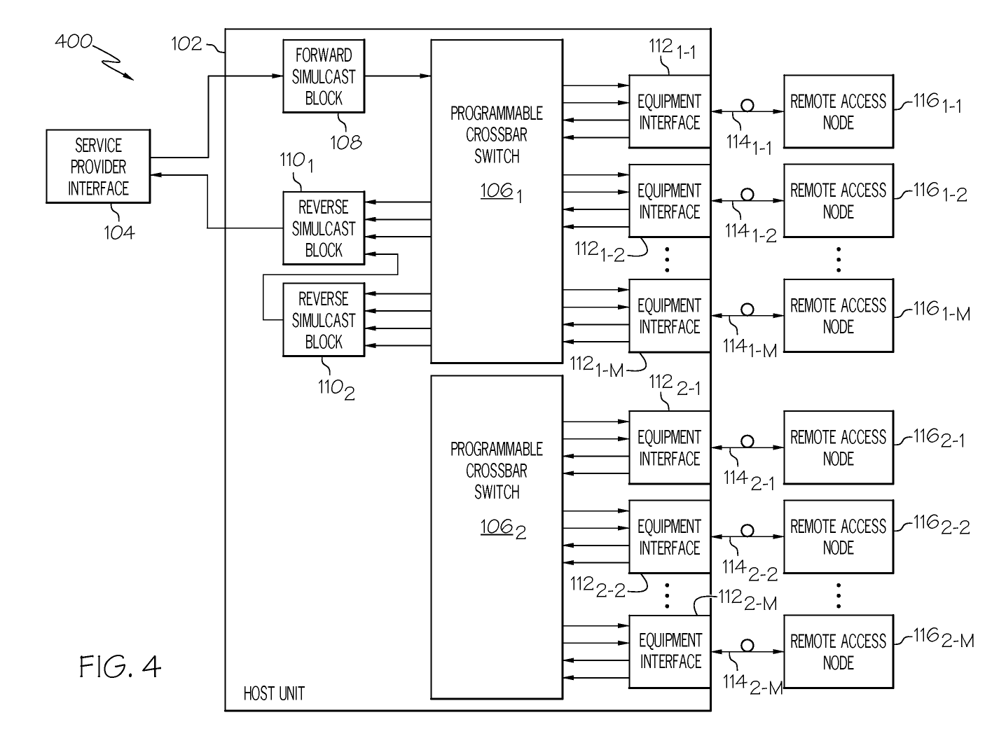

In operation, the programmable controller 204 receives a plurality of digital signal path configuration commands from the configuration block 208 and the external control connection at the configuration block output 228. From the configuration input port 226 and the configuration output port 228, the programmable controller 204 controls at least one digital signal path configuration of a plurality of input and output connections responsive to the device 200. In one implementation, the programmable controller 204 controls one or more additional programmable crossbar switches connected in series for routing of additional digital signals (discussed in further detail below with respect to FIG. 4). The programmable controller 204 automatically reroutes one or more of the plurality of input and output connections through existing external data connections as the device 200 continues to operate uninterrupted. As discussed above with respect to FIG. 1, the programmable controller 204 reconfigures the device 200 for simulcast transmissions of digital signals in the system 100.

The device 200, including the programmable controller 204 controlling the CSB 202 and the one or more HDCs 214, provides a plurality of input and output pairs within each of the one or more HDCs 214. The assembly 200 incorporates suitable electronic components that implement high-speed, simulcast-enabled electronic switching. The one or more high speed HDCs 214 route simulcast signal transmissions through the device 200 at the connection rate of at least 720 MHz without manual intervention.

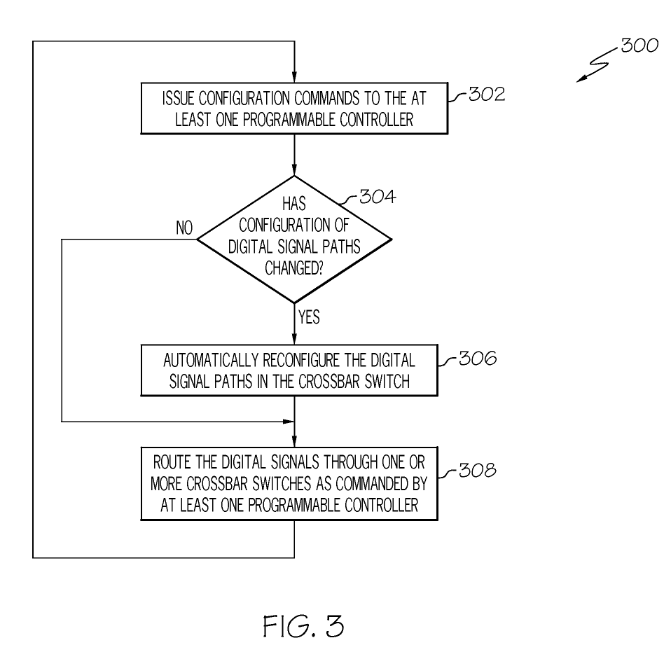

FIG. 3 is a flow diagram illustrating a method 300 for switching digital signals in the device 200 of FIG. 2 (that is, the programmable crossbar switch 106 of the system 100). The method 300 addresses configuring a plurality of digital signal paths with the programmable controller 204 from an external control connection. Based on configuration commands sent to the programmable controller 204, the method 300 controls a plurality of input and output connections (the equipment interfaces 112) for the plurality of digital signals by automatically revising the digital signal routing without manual intervention. In one implementation, controlling the plurality of input and output connections comprises routing the digital signals in the programmable crossbar switch 106 at a switching rate of at least 720 MHz. Moreover, automatically revising the digital signal routing in the programmable crossbar switch 102 without manual intervention comprises rerouting one or more of the signal paths provided by the equipment interfaces 112 through existing external data connections as the electronic crossbar switch 102 continues to operate.

At block 302, the external control connection issues the configuration commands to the programmable controller 204. If the configuration commands instruct the programmable controller to change the configuration of the plurality of digital signal paths (block 304), the programmable controller 204 (through the CSB 202) automatically reconfigures the programmable crossbar switch 106 for simulcast transmissions of the digital signals in the system 100 at block 306. At block 308, the CSB 202 continually routes the plurality of digital signals through one or more programmable crossbar switches 106 as commanded by the programmable controller 204. In one implementation, reconfiguring the programmable crossbar switch 106 for simulcast transmissions further comprises connecting one or more of the programmable crossbar switches 106 in series for routing of additional digital signals. Moreover, to connect the one or more programmable crossbar switches 106 in series comprises issuing configuration commands to the one or more programmable crossbar switches 106 from the programmable controller 204. The method 300 continues to operate with additional configuration commands (block 302).

As noted above, FIGS. 1 and 3 illustrate one embodiment of the system 100 and at least one associated operating method 300, respectively. It is to be understood that other embodiments are implemented in other ways. Indeed, the system 100 illustrated in FIGS. 1 and 3 is adaptable for a wide variety of applications. For example, FIG. 4 is a block diagram of an alternative embodiment of the system 100, a system 400. The embodiment of the electronic system 400 shown in FIG. 4 includes at least two programmable crossbar switches 106 with associated equipment interfaces 112 and remote access nodes 116. The two programmable crossbar switches 106 are individually referenced in FIG. 4 as programmable crossbar switches 106, and 1062, respectively. It is understood that the system 400 is capable of accommodating any appropriate number of the programmable crossbar switches 106 (for example, at least one programmable crossbar switch) in a single system 400.

In the example embodiment shown in FIG. 4, the system 300 further comprises equipment interfaces 112₁₋₁ to 112_{1-M} coupled to the programmable crossbar switch 106₁, and equipment interfaces 112₂₋₁ to 112_{2-M} coupled to the programmable crossbar switch 106₂. The equipment interfaces 112₁₋₁ to 112_{1-M} are individually coupled to remote access nodes 116₁₋₁ to 116_{1-M} via communication mediums 114₁₋₁ to 114_{1-M}, respectively. Similarly, the equipment interfaces 112₂₋₁ to 112_{2-M} are individually coupled to remote access nodes 116₂₋₁ to 116_{2-M} via communication mediums 114₂₋₁ to 114_{2-M}, respectively. In the example embodiment of FIG. 4, the programmable crossbar switches 106₁ and 106₂ are connected in series, as discussed above with respect to FIGS. 1 and 3.

While the methods and techniques described here have been described in the context of a fully functioning programmable high speed crossbar switch, apparatus embodying these techniques are capable of being distributed in the form of a computer readable medium of instructions and a variety of forms that apply equally regardless of the particular type of signal bearing media actually used to carry out the distribution. Examples of computer readable media include recordable-type media, such as a portable memory device; a hard disk drive (HDD); a random-access memory (RAM); a read-only memory (ROM); transmission-type media, such as digital and analog communications links; and wired (wireless) communications links using transmission forms, such as (for example) radio frequency and light wave transmissions. The computer readable media may take the form of coded formats that are decoded for actual use in a particular programmable high speed crossbar switch.

This description has been presented for purposes of illustration, and is not intended to be exhaustive or limited to the form (or forms) disclosed. Variations and modifications may occur, which fall within the scope of the embodiments described above, as set forth in the following claims.

What is claimed is:

1. A method for switching digital signals, the method comprising:
from an external control connection, configuring a plurality of digital signal paths with at least one crossbar switch;
based on the crossbar switch configuration, controlling a plurality of input and output connections for the digital signals; and
automatically revising the digital signal routing without manual intervention based on configuration commands from the external control connection.

2. The method of claim 1, wherein configuring the plurality of digital signal paths comprises reconfiguring the at least one crossbar switch for simulcast transmissions of the digital signals.

3. The method of claim 1, wherein configuring the plurality of digital signal paths comprises reconfiguring the at least one crossbar switch for simulcast transmissions of the digital signals with at least one programmable controller responsive to the at least one crossbar switch.

4. The method of claim 2, wherein reconfiguring at least one crossbar switch for simulcast transmissions further comprises connecting one or more additional crossbar switches in series for routing of additional digital signals.

5. The method of claim 4, wherein connecting the one or more additional crossbar switches in series comprises issuing the configuration commands to the one or more crossbar switches from the at least one crossbar switch.

6. The method of claim 1, wherein controlling the plurality of input and output connections comprises routing the digital signals at a switching rate of at least 720 MHz.

7. The method of claim 1, wherein automatically revising the digital signal routing without manual intervention comprises rerouting one or more of the plurality of input and output connections through existing external data connections responsive to the at least one crossbar switch.

8. An electronic digital signal switching device, comprising:
a programmable controller;
a configuration block in communication with the programmable controller, the configuration block receives a plurality of digital signal path configuration commands from an external control connection;
a crossbar switching block in communication with the programmable controller, the crossover switching block responsive to the plurality of digital signal path configuration commands received by the configuration block; and
a plurality of high density connectors operatively coupled to the crossbar switching block, the plurality of high density connectors responsive to at least one digital signal path configuration from the programmable controller at a switching rate of at least 720 MHz.

9. The device of claim 8, and further comprising:
a downstream port transmit and receive block responsive to the programmable controller, the downstream port transmit and receive block operatively coupled to the crossbar switching block;
an upstream port transmit and receive block responsive to the programmable controller, the upstream port transmit and receive block operatively coupled to the crossbar switching block; and
a controller memory block responsive to the programmable controller, the controller memory block stores the plurality of digital signal path configuration commands.

10. The device of claim 9, wherein the downstream port transmit and receive block transmits and receives the digital signals to and from one or more additional electronic digital signal switching devices stacked downstream from the electronic digital signal switching device.

11. The device of claim 9, wherein the upstream port transmit and receive block transmits and receives the digital signals to and from one or more additional electronic digital signal switching device stacked upstream from the electronic digital signal switching device.

12. The device of claim 9, wherein the downstream port transmit and receive block and the upstream port transmit and receive block comprise a serializer/deserializer device.

13. The device of claim 8, wherein the programmable controller is at least one of a microcontroller, an application-specific integrated circuit, a field-programmable gate array, a field-programmable object array, and a programmable logic device.

14. The device of claim 8, wherein the configuration block is responsive to a configuration input port that receives the plurality of digital signal path configuration commands from a single source.

15. The device of claim 8, wherein the configuration block is responsive to:
a configuration input port that receives the plurality of digital signal path configuration commands from an additional downstream electronic digital signal switching device; and
a configuration output port that provides additional digital signal path configuration commands from the programmable controller to one or more of the additional downstream electronic digital signal switching devices for routing of additional digital signals.

16. The device of claim 15, wherein the additional downstream electronic digital signal switching device is an upstream electronic digital signal switching device.

17. The device of claim 8, wherein the configuration block comprises an inter-IC (integrated circuit) bus that transfers the plurality of digital signal path configuration commands to the programmable controller.

18. The device of claim 8, wherein the crossbar switching block comprises:
a plurality of input ports operatively coupled to the plurality of high density connectors;
a plurality of output ports operatively coupled to the plurality of high density connectors; and
wherein the plurality of input ports and the plurality of output ports provide one or more digital signal paths through the electronic digital signal switching device for simulcast transmissions of digital signals in a telecommunications system.

19. The device of claim 18, wherein the plurality of input ports and the plurality of output ports are coupled to the plurality of high density connectors with a plurality of signal logic blocks.

20. The device of claim 19, wherein the plurality of signal logic blocks comprises emitter-coupled, low voltage differential signaling logic.

21. The device of claim 8, wherein the crossbar switching block is at least one of a microcontroller, an application-specific integrated circuit, a field-programmable gate array, a field-programmable object array, and a programmable logic device.

22. The device of claim 8, wherein the plurality of high density connectors remain connected as a plurality of digital signal path connections are automatically rerouted to form the at least one digital signal path configuration while the electronic digital signal switching device continues to operate.

23. A telecommunications system, comprising:
a service provider interface;
at least one head end unit responsive to the service provider interface, the at least one head end unit including:
one or more reverse simulcast blocks,
at least one forward simulcast block, and
at least one programmable crossbar switch providing at least one automated data signal path configuration between the forward simulcast block and the one or more reverse simulcast blocks; and
one or more remote access nodes coupled to the programmable crossbar switch over a communication medium, the one or more remote access nodes supported by the at least one automated data signal path configuration in an electronic simulcast telecommunications transmission.

24. The system of claim 23, wherein the at least one automated data signal path configuration operates at a switching rate of at least 720 MHz.

25. The system of claim 23, wherein the communication medium is at least one of optical fiber, free space optics, high speed copper, and wireless (RF) communications.

26. The system of claim 23, wherein the one or more remote access nodes are coupled to the programmable crossbar switch through one or more equipment interfaces.

27. The system of claim 26, wherein the one or more equipment interfaces amplify, combine and transmit the electronic simulcast telecommunications transmission over the communication medium.

28. The system of claim 23, wherein the service provider interface provides an interface to at least one of digital cellular service, personal communication services, specialized mobile radio services, video services, and wireless broadband internet services.

29. The system of claim 23, wherein the service provider interface:
sends forward simulcast telecommunications transmissions to the least one programmable crossbar switch; and
receives reverse simulcast telecommunications transmissions from the at least one programmable crossbar switch.

30. The system of claim 23, wherein the at least one programmable crossbar switch is connected in series with one or more additional programmable crossbar switches for routing of additional electronic simulcast telecommunications transmissions.

31. A program product comprising program instructions, embodied on a storage medium, the program instructions cause at least one programmable processor in a programmable high speed crossbar switch to:
receive a plurality of digital signal path configuration commands from an external control connection;
control at least one digital signal path configuration of a plurality of input and output connections responsive to the programmable high speed crossbar switch; and
automatically reroute one or more of the plurality of input and output connections through existing external data connections as the programmable high speed crossbar switch continues to operate.

32. The program product of claim 31, wherein the program instructions that receive the plurality of digital signal path configuration commands cause the at least one programmable processor to complete one or more configuration updates at a switching rate of at least 720 MHz.

33. The program product of claim 31, wherein the program instructions that control the at least one digital signal path configuration cause the at least one programmable processor to control one or more additional programmable high speed crossbar switches connected in series for routing of additional digital signals.

34. The program product of claim 31, wherein the program instructions that automatically reroute one or more of the plurality of input and output connections through existing external data connections cause the at least one programmable processor to reconfigure the programmable high speed crossbar switch for simulcast transmissions of digital signals in a telecommunications system.
